(19) United States
(12) Patent Application Publication
(10) Pub. No.: US 2005/0083185 A1
(43) Pub. Date: Apr. 21, 2005

(54) Cold-light indicating and warning meter

(76) Inventor: Ching-Hung Wang, Taipei (TW)

Correspondence Address: TROXELL LAW OFFICE PLLC;SUITE 1404, 5205 LEESBURG PIKE, FALLS CHURCH, VA, 22041, US

(21) Appl. No.: 10/684,482

(22) Filed: Oct. 15, 2003

(51) Int. Cl. B60Q 1/00

(52) U.S. Cl. 340/438

(57) ABSTRACT

A cold-light indicating and warning meter for car mainly includes a plurality of concentric cold-light rings simultaneously provided on a surface panel of the meter. With a control unit of the meter, readings representing engine speed, car speed, engine temperature, fuel level, etc. are separately shown on the same meter via light and shade of the cold-light rings, so that a driver may have an idea about the conditions of the whole car by observing only one meter.

### FIELD OF THE INVENTION

The present invention relates to a meter for car, and more particularly to a meter that is provided on one single meter dial with multiple cold-light rings to show different conditions of a running car.

### BACKGROUND OF THE INVENTION

Various kinds of meters or gauges are used to show different conditions of a car in moving. Some meters and gauges that are common to all cars include tachometer, speedometer, engine temperature gauge, fuel indicator, etc. These different meters and gauges are normally separately mounted on a dashboard of the car to show different readings with pointers. With the development of cold-light panel, dials and pointers provided with these meters and gauges could now be replaced with cold-light panels, and different readings are indicated via light and shade on the cold-light panels. The purpose of using the cold-light panel on meters and gauges is to reduce the space occupied by the mechanical structure of the conventional meters and gauges with dials and pointers, and to enable a driver to see the readings easily.

However, the conventional cold-light panels used to replace the dials and pointers are thin panels separately mounted on individual meters or gauges. Therefore, the driver has to watch different meters or gauges to have an idea about the conditions of the whole car. For example, as it is known, there is a close relation between engine speed and car speed. The driver watching the speedometer would not be able to watch the tachometer at the same time, and therefore could not contrast the two meters with one another to ascertain whether the car is in a normal condition. This is a big disadvantage of the conventional meters or gauges using cold-light panels.

It is therefore tried by the inventor to show all values indicating different conditions of a car on one single meter using multiple cold-light rings, so that the driver may observe all readings at the same time to have a complete idea about the current conditions of the car.

### SUMMARY OF THE INVENTION

A primary object of the present invention is to provide a cold-light indicating and warning meter that includes a plurality of concentric cold-light rings simultaneously provided on a meter dial of the meter. With a control unit of the meter, values representing engine speed, car speed, engine temperature, fuel level, etc. are separately shown on the same meter via light and shade of the cold-light rings, so that a driver may have an idea about the conditions of the whole car by observing only one meter.

Another object of the present invention is to provide a cold-light indicating and warning meter, on which multiple cold-light rings are provided to indicate different readings via light and shade of the cold-light rings, so that the driver may conveniently observe and contrast different readings with one another at the same time. For example, the driver may contrast the engine speed with the car speed, and when it is found, for example, the car speed does not increase when the engine revolution has been increased, it indicates there is some problem with the car.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing the structure of a cold-light indicating and warning meter according to an embodiment of the present invention;

FIG. 2 shows the layout of multiple cold-light rings on a meter top of the cold-light indicating and warning meter of the present invention; and

FIG. 3 is a block diagram of a control unit included in the cold-light indicating and warning meter of the present invention.

### DETAILED DESCRIPTION OF THE PREFERRED EMBODIMENTS

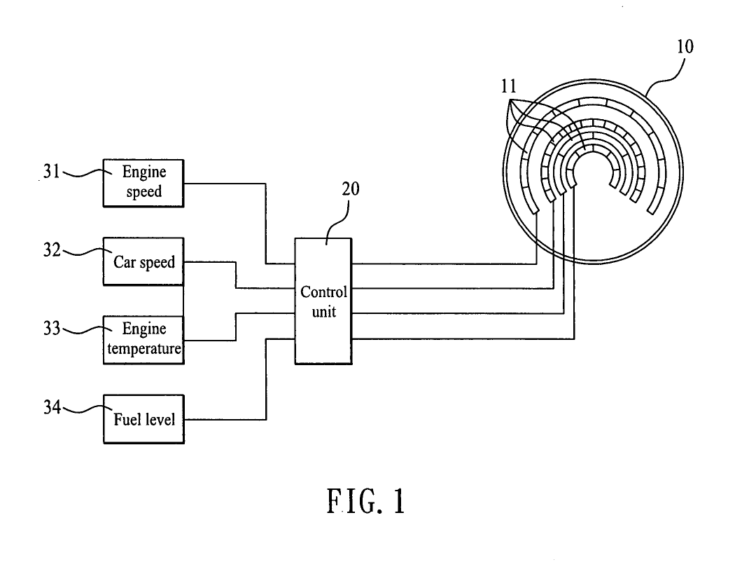

Please refer to FIG. 1. The cold-light indicating and warning meter according to the present invention includes a meter top 10 for mounting behind a steering wheel of a car for easy observation by the driver. The meter top 10 is provided on a surface panel with a plurality of concentric cold-light rings 11. Each of the cold-light rings 11 shows light and shade to indicate a specific reading representing a detected condition of the car.

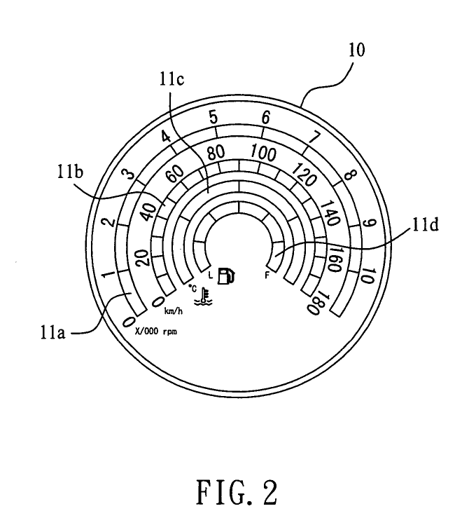

FIG. 2 shows an example of layout of the cold-light rings 11 on the meter top 10. A radially outmost one of the cold-light rings 11 is an engine speed indicating and warning ring 11a showing the engine speed of the car. Graduations are provided along a radially outer side of the ring 11a to facilitate easy determination of the reading shown by light and shade on the ring 11a. A second cold-light ring adjacent to a radially inner side of the first ring 11a is a car speed indicating and warning ring 11b showing the speed of the car. Again, there are graduations provided along a radially outer side of the second ring 11b. A third cold-light ring adjacent to a radially inner side of the second ring 11b is an engine temperature indicating and warning ring 11c. And, an innermost ring is a fuel indicating and warning ring 11d to show the fuel level of the car. On all the cold-light rings 11a to 11d, warning scales are provided to allow easy determination as to whether a luminous part of a cold-light ring has exceeded the warning scale and therefore provide very good warning effect. Alternatively, the cold-light rings may be otherwise divided into several different colors to achieve the same good warning effect.

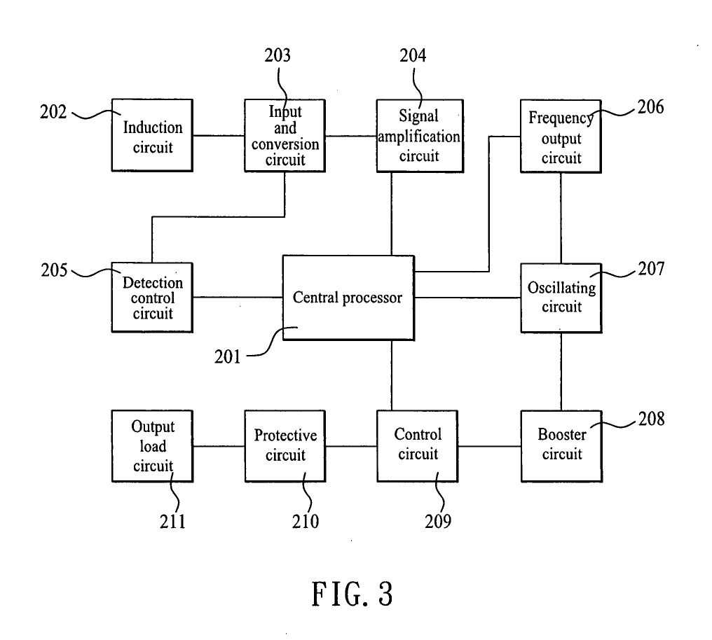

The meter top 10 includes a control unit 20 adapted to input various kinds of detected signals, such as an engine speed signal 31, a car speed signal 32, an engine temperature signal 33, and a fuel level signal 34 shown in FIG. 1, into the meter top 10. Circuits are provided inside the control unit 20 for controlling the cold-light rings 11 on the meter top 10 to properly light and show readings. Please refer to FIG. 3 that is a block diagram of the control unit 20. As shown, the control unit 20 mainly includes a central processor 201; an induction circuit 202 electrically connected to detectors (not shown) provided on the car to obtain signals from the detectors; an input conversion circuit 203 and a signal amplification circuit 204 for processing the signals obtained by the induction circuit 202 and sending the processed signals to the central processor 201; a detection control circuit 205 electrically connected to the input conversion circuit 203 for sending a confirming input signal to notify the central processor 201; a frequency output circuit 206, an oscillating circuit 207, and a booster circuit 208 for receiving from the central processor 201 signals obtained through operation of the central processor 201 to excite voltage and current required for lighting the cold-light rings; a control circuit 209 serving as a switch; and a protective circuit 210 adapted to cause a load circuit 211, that is, the cold-light rings, to light under control of the control circuit 209.

The control unit 20 and the meter top 10 are specially designed to allow mounting of them to a car simply by connecting various existing detecting signal lines to the control unit 20, and detected conditions may be shown on the meter top 10 through the light and shade of the cold-light rings 11.

In the illustrated embodiment, there are four concentric cold-light rings 11 provided on the meter top 10. However, it is understood more cold-light rings 11 may be provided depending on actual need to show more conditions of car that could be expressed in numeral form. In addition, the meter top 10 is not necessarily in the illustrated round shape but may be, for example, in a square or a rectangular shape; and the cold-light rings 11 may be extended along the meter top 10 to have a shape corresponding to that of the meter top 10. Such changes in the number and the shape of the cold-light rings may be accomplished without departing from the spirit of the present invention and therefore should be included in the scope of the present invention as defined by the appended claims.

1. A cold-light indicating and warning meter, comprising:
a meter top having a surface panel on which a plurality of cold-light rings are radially sequentially arranged; and
a control unit adapted to receive signals representing different conditions of a car that could be expressed in numeral form, and said received signals being operated and converted by said control unit so as to cause said cold-light rings on said meter top to show light and shade and thereby indicate readings representing said different conditions of the car.

2. The cold-light indicating and warning meter as claimed in claim 1, wherein said meter top includes graduations provided along a radially outer side of each said cold-light ring.

3. The cold-light indicating and warning meter as claimed in claim 1, wherein said meter top includes warning scales provided on each of said cold-light rings.

4. The cold-light indicating and warning meter as claimed in claim 1, wherein said control unit includes a central processor; an induction circuit electrically connected to detectors provided on the car to obtain signals from said detectors; an input conversion circuit and a signal amplification circuit for processing said signals obtained by said induction circuit and inputting said processed signals to said central processor; a detection control circuit electrically connected to said input conversion circuit for sending a confirming input signal to notify said central processor; a frequency output circuit, an oscillating circuit, and a booster circuit for receiving from said central processor signals obtained through operation of said central processor to energize voltage and current required for lighting said cold-light rings; a control circuit serving as a switch; and a protective circuit adapted to cause a load circuit to light said cold-light rings under control of said control circuit.

5. The cold-light indicating and warning meter as claimed in claim 4, wherein said signals input to said control unit include at least an engine speed signal, a car speed signal, an engine temperature signal, and a fuel level signal, and wherein said cold-light rings provided on said meter top include at least four rings.
